(19) United States
(12) Patent Application Publication
(10) Pub. No.: US 2022/0023138 A1
(43) Pub. Date: Jan. 27, 2022

(54) CONTOURED MUSCLE RECOVERY DEVICE

(71) Applicant: Mitchell Reeg, Orlando, FL (US)

(72) Inventor: Mitchell Reeg, Orlando, FL (US)

(21) Appl. No.: 16/935,032

(22) Filed: Jul. 21, 2020

(51) Int. Cl. A61H 15/00

(52) U.S. Cl. CPC A61H 15/0092; A61H 2015/0035; A61H 2201/169; A61H 2201/0153; A61H 2015/0064

(57) ABSTRACT

A muscle recovery device includes an elongated, generally tubular shaped main body having a first end, a second end and a middle section. Handles are positioned along the first and second ends, and a plurality of independently operable rollers are secured along the length of the main body at locations between the handles. The main body including a curvilinear shape and each of the rollers are positioned perpendicular to the curved portion of the main body to which each roller is secured so as to be positioned angularly to another roller. Each of the rollers are removably positioned along the main body and have an adjustable separation distance.

### TECHNICAL FIELD

The present invention relates generally to muscle recovery devices, and more particularly to a contoured muscle recovery device utilizing a plurality of independent rollers.

### BACKGROUND

The statements in this section merely provide background information related to the present disclosure and may not constitute prior art.

There are known devices geared toward applying localized pressure onto various muscle groups of the body in order to perform a stretching operation on the same. One of the most popular devices comprises a single, elongated rolling tube having a planar orientation, that can be rolled along one or more major muscle groups of a user after strenuous activities such as weightlifting, running or general exercise, for example.

Although these devices are capable of being used on different portions of the body, the most common place they are actually used are along a user's arms and legs. Unfortunately, the use of a single, elongated rigid roller is not able to conform to the shape of the user's arms and legs, and therefore is only able to engage a small portion of the arm and leg muscles at any given time. As a result, the use of such devices requires users to perform many individual passes, with each pass engaging only a fraction of the muscle at any given time. As such, these current devices are highly inefficient as they delay the recovery process, and also function to increase the manual efforts needed to effectuate the same.

The present invention directed to a contoured recovery roller device differs from the conventional art in a number of aspects. The manner by which will become more apparent in the description which follows, particularly when read in conjunction with the accompanying drawings.

### SUMMARY OF THE INVENTION

The present invention is directed to a muscle recovery device. One embodiment of the present invention can include an elongated, generally tubular shaped main body having a first end, a second end and a middle section. Handles can be positioned along the first and second ends and function to facilitate gripping and operation of the device. In one embodiment, a plurality of independently operable rollers can be secured along the length of the main body at locations between the handles.

In one embodiment, the main body can include a curvilinear shape and each of the rollers can be positioned perpendicular to the curved portion of the main body to which each roller is secured. As such, each of the rollers can be positioned angularly to another roller.

In one embodiment, each of the rollers can be removably positioned along the main body so as to allow a user to selectively position a specific number of rollers and to adjust a separation distance between the specific number of rollers.

This summary is provided merely to introduce certain concepts and not to identify key or essential features of the claimed subject matter.

### BRIEF DESCRIPTION OF THE DRAWINGS

Presently preferred embodiments are shown in the drawings. It should be appreciated, however, that the invention is not limited to the precise arrangements and instrumentalities shown.

FIG. 1 is a perspective view of one embodiment of a contoured muscle recovery device that is useful for understanding the inventive concepts disclosed herein.

FIG. 2 is a cross sectional view of the contoured muscle recovery device, in accordance with one embodiment of the invention.

FIG. 3 is a perspective view of the contoured muscle recovery device, in accordance with one embodiment of the invention.

FIG. 4 is a perspective view of the contoured muscle recovery device in operation, in accordance with one embodiment of the invention.

### DETAILED DESCRIPTION OF THE INVENTION

While the specification concludes with claims defining the features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention which can be embodied in various forms. Therefore, specific structural and functional details disclosed herein are not to be interpreted as limiting, but merely as a basis for the claims and as a representative basis for teaching one skilled in the art to variously employ the inventive arrangements in virtually any appropriately detailed structure. Further, the terms and phrases used herein are not intended to be limiting but rather to provide an understandable description of the invention.

### Definitions

As described throughout this document, the term “complementary shape,” and “complementary dimension,” shall be used to describe a shape and size of a component that is identical to, or substantially identical to the shape and size of another identified component within a tolerance such as, for example, manufacturing tolerances, measurement tolerances or the like.

As described herein, the term “about” when used in connection with a referenced numeric indication means the referenced numeric indication plus or minus up to 10 percent of that referenced numeric indication. For example, “about 100” means from 90 to 110.

As described herein, the term “removably secured” and derivatives thereof shall be used to describe a situation wherein two or more objects are joined together in a non-permanent manner so as to allow the same objects to be repeatedly joined and separated. Several nonlimiting examples include thread-to-connect, twist-to-connect, and push-to-connect, and may be facilitated through the use of any number of connectors such as opposing strips of hook and loop material (i.e. Velcro®), magnets, and/or compression fittings such as locking pins, male and female fittings, clamps, nut/bolts, tethers (e.g., zip ties), snaps and buttons, for example.

Moreover, the term “permanently secured” shall be used to describe a situation wherein two or more objects are joined together in a manner so as to prevent the same objects from being separated. Several nonlimiting examples include various adhesives such as glue or resin, hardware such as nuts and bolts, and welds, for example.

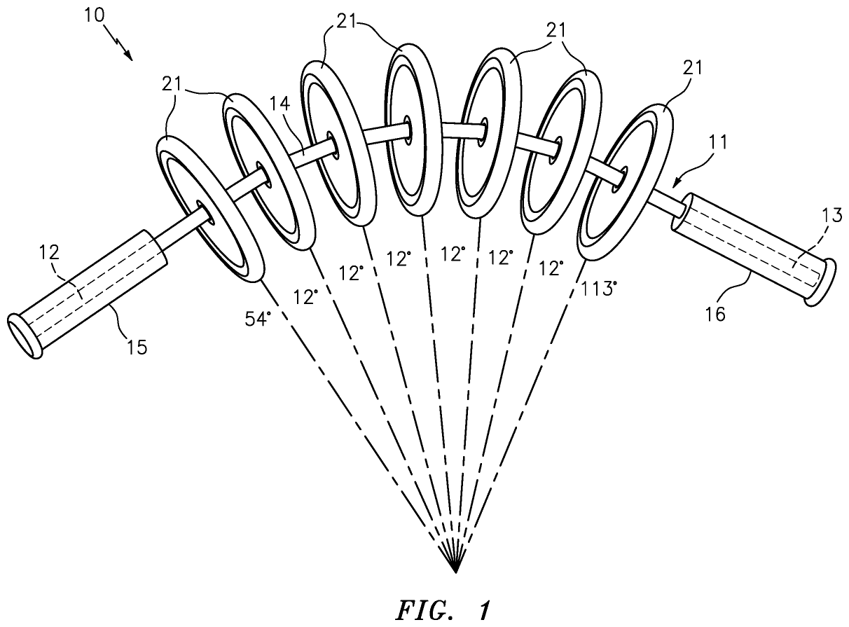

FIGS. 1-4 illustrate one embodiment of a contoured muscle recovery device 10 that are useful for understanding the inventive concepts disclosed herein. In each of the drawings, identical reference numerals are used for like elements of the invention or elements of like function. For the sake of clarity, only those reference numerals are shown in the individual figures which are necessary for the description of the respective figure. For purposes of this description, the terms “upper,” “bottom,” “right,” “left,” “front,” “vertical,” “horizontal,” and derivatives thereof shall relate to the invention as oriented in FIG. 1.

As shown in FIG. 1, one embodiment of the device 10 can include an elongated tubular body 11 onto which a plurality of rollers 21 can be positioned. In the preferred embodiment, the tubular body can include the illustrated curvilinear shape having a first end 12, a second end 13 and a middle section 14.

As described herein, the main body 11 may be formed from any number of materials that are, for example, relatively strong and stiff for their weight. Several nonlimiting examples include, but are not limited to various metals or metal alloys (e.g., aluminum, steel, titanium, or alloys thereof), plastic/polymers (e.g., high-density polyethylene (HDPE), rigid polyvinyl chloride (PVC), or polyethylene terephthalate (PET)), and/or various natural (e.g., wood) or composite materials.

As shown, a pair of handles 15 and 16 can be positioned along first end 12 and second end 13, respectively. Handles 15 and 16 can preferably be constructed from any number of resilient materials such as foam or rubber, for example, and can be removably or permanently affixed onto the main body via connectors so as to remain in a fixed orientation during device usage.

In one embodiment, a plurality of independently operable rollers 21 can be positioned along the length of the main body 11 between the handles 15 and 16. As such, each of the rollers can be positioned perpendicular to the curved portion of the main body to which that roller is secured. In this regard, each roller will be oriented angularly along the main body so as to be able to contour to the shape of a user's arms and legs as described below.

In one nonlimiting exemplary embodiment, the device can include seven rollers 21 each having a relative angular offset of 12° and can extend between about 54° and 112° relative to a central axis. Such dimensions and angles being specifically chosen to allow the device to conform to the top and sides of an average adult male. Of course, the device is not limited to the use of any particular number, orientation or angle of rollers, as many other embodiments contemplating different numbers, orientations and angles of rollers are contemplated.

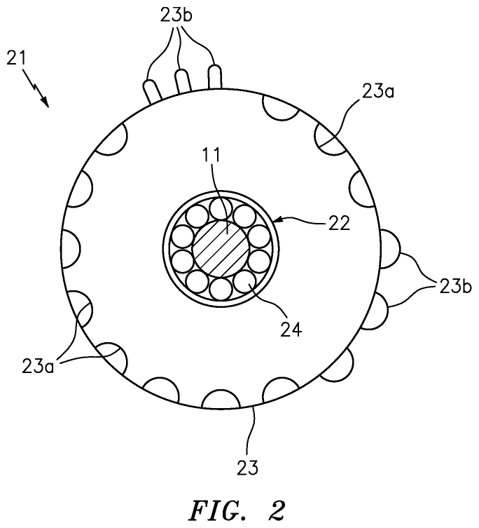

As shown best at FIG. 2, each of the rollers 21 can include a generally circular shaped body having a central aperture 22 and an outside surface 23. A bearing assembly 24 is positioned within the central aperture and can function to secure the roller to the main body 11 while permitting rotation of the outside surface.

In the preferred embodiment, each of the rollers can include a width of about 1 inch, an outside diameter of about 3 inches, and can be constructed from polyurethane. Of course, any number of other sizes and construction materials are also contemplated. In either instance, the outside surface 23 of each of the rollers can include any number of different textures so as to provide a different feel to the end user. In this regard, one or more of the rollers may include a generally smooth surface (e.g., lacking indentations or protrusions) or may include any number of ridges, indentations 23a and/or protrusions 23b of varying shapes and sizes.

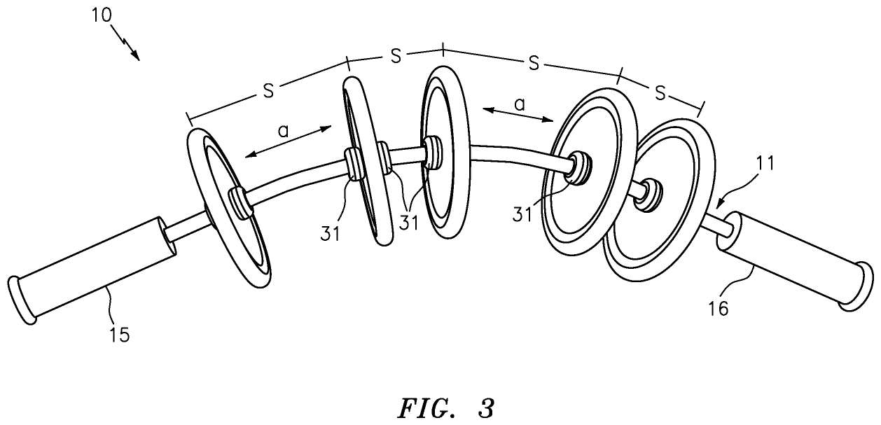

In one embodiment, each of the rollers 21 can be removably positioned onto the main body 11 via connectors 31 that are engaged to the bearing assembly and main body. As shown at FIG. 3, this allows a user to customize the device 10 to their preferences by adjusting the number of rollers 21 and/or the spacing S between each of the rollers themselves as shown by arrows a.

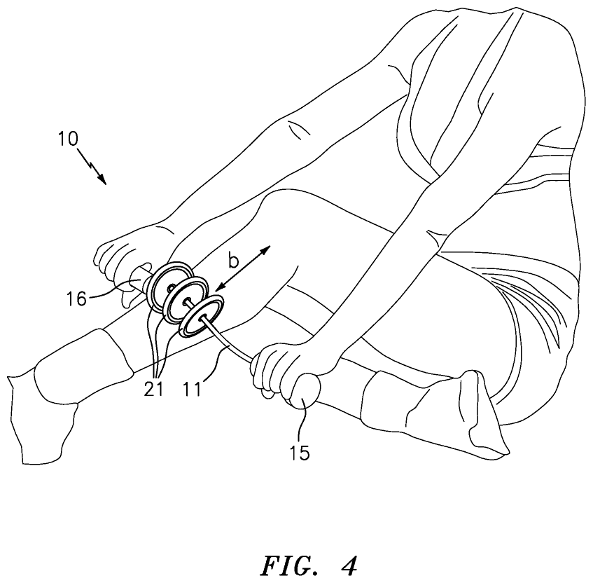

FIG. 4 illustrates one embodiment of the device 10 in operation to engage the muscles of a user's leg. As shown, the user can grasp the handles 15 and 16 and position the rollers 21 onto their leg. Next, the user can move the device back and forth (see arrow b) along the length of their leg whereby the angled rollers can engage and massage the top and both sides of the leg simultaneously.

As to a further description of the manner and use of the present invention, the same should be apparent from the above description. Accordingly, no further discussion relating to the manner of usage and operation will be provided.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Likewise, the terms “consisting” shall be used to describe only those components identified. In each instance where a device comprises certain elements, it will inherently consist of each of those identified elements as well.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

1. A muscle recovery device, comprising:
an elongated tubular shaped main body having a first end, a second end and a middle section;
a first handle that is disposed along the first end of the main body;
a second handle that is disposed along the second end of the main body; and
a plurality of independently operable rollers that are positioned along the middle section of the main body.

2. The device of claim 1, wherein the main body includes a curvilinear shape.

3. The device of claim 2, wherein each of the plurality of independently operable rollers is positioned perpendicular to a section of the main body to which the roller is secured.

4. The device of claim 1, wherein each of the plurality of independently operable rollers includes a circular-shaped body having an outside surface and a central aperture.

5. The device of claim 4, wherein the outside surface of at least one of the plurality of independently operable rollers includes a plurality of indentations.

6. The device of claim 4, wherein the outside surface of at least one of the plurality of independently operable rollers includes a plurality of protrusions.

7. The device of claim 4, wherein the outside surface of at least one of the plurality of independently operable rollers includes a plurality of indentations and a plurality of protrusions.

8. The device of claim 4, wherein the outside surface of at least one of the plurality of independently operable rollers is smooth.

9. The device of claim 4, further comprising a bearing assembly that is positioned within the central aperture of each of the plurality of independently operable rollers.

10. The device of claim 9, wherein the bearing assembly of each of the plurality of independently operable rollers is in communication with the main body.
